(19) United States
(12) Patent Application Publication
(10) Pub. No.: US 2014/0232843 A1
(43) Pub. Date: Aug. 21, 2014

(54) Gain Value of Image Capture Component

(71) Applicant: Robert Campbell, Cupertino, CA (US)

(72) Inventor: Robert Campbell, Cupertino, CA (US)

(21) Appl. No.: 14/350,563

(22) PCT Filed: Oct. 27, 2011
(86) PCT No.: PCT/US2011/058189

§ 371 Date: Apr. 8, 2014

(51) Int. Cl. H04N 5/235; H04N 7/18

(52) U.S. Cl. CPC H04N 5/2351; H04N 7/18
USPC 348/78; 348/77

(57) ABSTRACT

A device to detect an object within proximity of the device, identify a brightness level of the object and modify a gain value of an image capture component based on the brightness level, determine whether the object includes a face, and capture an image of the face if the face is detected.

### BACKGROUND

When logging into a device, a user can access an input component to enter a username and/or a password for the device to authenticate the user. Alternatively, the device can include an image capture component to scan an image of the user's fingerprint or to capture an image of the user's face for authenticating the user. The image capture component can detect an amount of light in a background of the device and modify a brightness setting of the image capture component. This can lead to unsuitable or poor quality images as a captured image of the user may be over saturated or under saturated based on the image capture component modifying a brightness setting using the amount of light in the background of the device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device coupled to an image capture component according to an example.

FIG. 2 illustrates an image capture component detecting an object according to an example.

FIG. 3A illustrates a block diagram of an interface application identifying a brightness level of an object according to an example.

FIG. 3B illustrates a block diagram of an interface application using a modified gain value for an image capture component according to an example implementation.

FIG. 4 is a flow chart illustrating a method for detecting a user according to an example.

FIG. 5 is a flow chart illustrating a method for detecting a user according to another example.

### DETAILED DESCRIPTION

A device can include an image capture component to detect for an object within proximity of the device by capturing a view of an environment around the device. The environment includes a location of where the device is located. An object can be a person or an item which is present in the environment. If an object is detected, the device can identify a brightness level of the object. The device can detect for light reflected from a surface of the object to identify the brightness level of the object. Based on the brightness level of the object, the device can modify a gain value of the image capture component. Modifying the gain value can include using the brightness value of the object as a midpoint for a dynamic range of the image capture component.

By using the brightness value of the object as a midpoint for the dynamic range as opposed to a default brightness value or a brightness value of a background of the device, the device can modify the gain value of the image capture component such that a view or image of the object captured is not over saturated or under saturated. As a result, the image capture component can clearly capture details of the object to determine whether the object is a person. The object can be a person if the device detects a face on the object. If a face is detected, the image capture component can capture an image of the face for the device to authenticate the person.

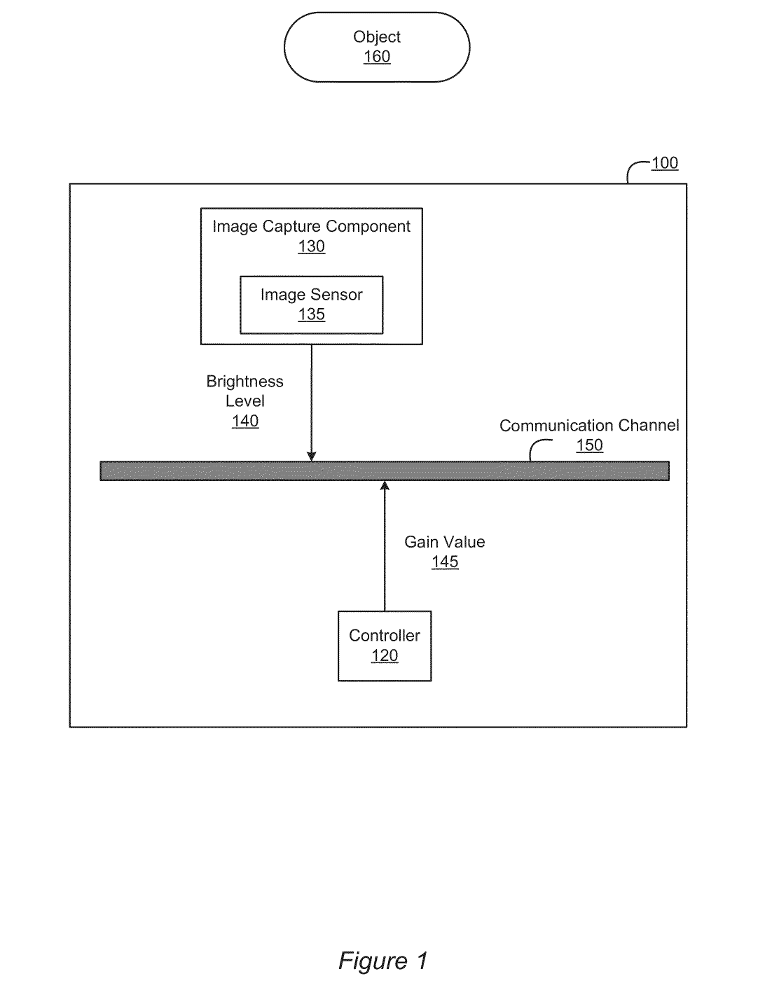

FIG. 1 illustrates a device 100 coupled to an image capture component 130 according to an example. The device 100 can be a laptop, a notebook, a tablet, a netbook, an all-in-one system, and/or a desktop. In another embodiment, the device 100 can be a cellular device, a PDA (Personal Digital Assistant), an E (Electronic)-Reader, and/or any additional device which can be coupled to an image capture component 130.

The device 100 includes a controller 120, an image capture component 130 with an image sensor 135, and a communication channel 150 for components of the device 100 to communicate with one another. In one embodiment, the device 100 additionally includes an interface application which can be utilized independently and/or in conjunction with the controller 120 to manage the device 100. The interface application can be a firmware or application which can be executed by the controller 120 from a non-transitory computer readable memory accessible to the device 100.

When managing the device 100, the controller 120 and/or the interface application can utilize the image capture component 130 to detect for an object 160 within proximity of the device 100. For the purposes of this application, an image capture component 130 is a hardware component of the device 100 configured to capture a view of an environment of the device 100 to detect for an object 160. The image capture component 130 can include a camera, a webcam, and/or any additional hardware component with an image sensor 135 to capture a view of an environment of the device 100. The environment includes a location of where the device 100 is located. The image sensor 135 can be a CCD (charge coupled device) sensor, a CMOS (complementary metal oxide semiconductor) sensor, and/or any additional sensor which can be used to capture a visual view.

An object 160 can be an item or person present in the environment of the device 100. When detecting for an object 160 within proximity of the device 100, the image capture component 130 can detect for motion in the environment. The image capture component 130 can use motion detection technology to detect for an item or person moving in the environment. Any item or person moving in the environment is identified by the controller 120 and/or the interface application as an object 160.

In response to detecting an object 160 in the environment, the controller 120 and/or the interface application use the image capture component 130 to identify a distance of the object 160 to determine if the object 160 is within proximity of the device 100. In one embodiment, the image capture component 130 can emit one or more signals and use a time of flight response from the object 160 to identify the distance of the object 160. The controller 120 and/or the interface application can compare the distance of the object 160 to a predefined distance to determine if the object 160 is within proximity of the device 100.

The predefined distance can be based on a distance which a user of the device 100 may typically be within for the image capture component 130 to capture an image of the user's face. If the identified distance is greater than the predefined distance, the object 160 will be determined to be outside proximity and the controller 120 and/or the interface application can use the image capture component 130 to continue to detect for an object 160 within proximity of the device 100. If the identified distance of the object 160 is less than the predefined distance, the controller 120 and/or the interface application will determine that the object 160 is within proximity of the device 100.

In response to detecting an object 160 within proximity of the device 100, the controller 120 and/or the interface application can identify a brightness level 140 of the object 160. For the purposes of this application, a brightness level 140 of the object 160 corresponds to how luminous or how much light the object 160 reflects. Identifying the brightness level 140 of the object 160 can include the image capture component 130 detecting an amount of light reflected from a surface of the object 160. In one embodiment, the image capture component 130 can detect for an amount of ambient light reflected from a surface of the object 160. In another embodiment, the image capture component 130 can emit one or more signals as wavelengths and detect an amount of light reflected from a surface of the object 160.

The amount of light reflected from the surface of the object 160 can be identified by the controller 120 and/or the interface application as a brightness level 140 of the object 160. The controller 120 and/or the interface application can use the brightness level 140 to modify a gain value 145 of the image capture component 130. The gain value 145 corresponds to an amount of power supplied to the image sensor 135 and is based on a midpoint of a dynamic range for the image sensor 135. The dynamic range includes a range of brightness levels which the image sensor 130 of the image capture component 130 can detect.

In one embodiment, modifying the gain value 145 includes the controller 120 and/or the interface application using the identified brightness level 140 of the object 160 as the midpoint for the dynamic range of brightness levels. The image sensor 135 can include a default dynamic range of brightness levels with a default midpoint. The default midpoint corresponds to a median brightness level of the dynamic range of brightness levels.

If the identified brightness level 140 of the object 160 is greater than the default midpoint, the controller 120 and/or the interface application can overwrite the default midpoint of the dynamic range and decrease the gain value 145 of the image sensor 135 accordingly. As a result, an amount of power supplied to the image sensor 135 is decreased for the image capture component 130 to decease a brightness of a captured view. By decreasing the brightness of the captured view, the object does not appear oversaturated and details of the object are not lost or washed out.

In another embodiment, if the identified brightness level 140 of the object 160 is less than the default midpoint, the controller 120 and/or the interface application overwrite the default midpoint and increase the gain value 145 of the image sensor 135 accordingly. As a result, more power is supplied to the image sensor 135 for the image capture component 130 to increase a brightness of a captured view. By increasing the brightness of the captured view, the object does not appear under saturated and details of the object become more visible and clear.

As the image capture component 130 is capturing a view of the object 160 with the modified gain value 145, the controller 120 and/or the interface application can determine whether the object 160 is a person by detecting for a face on the object 160. The controller 120 and/or the interface application can use facial detection technology and/or eye detection technology to determine whether the object 160 includes a face. If a face or eyes are detected on the object 160, the controller 120 and/or the interface application instruct the image capture component 130 to capture an image of the face.

The controller 120 and/or the interface application can compare the image of the face to images of one or more recognized users of the device 100 to authenticate the user. If the captured face matches an image of a recognized user of the device 100, the person will have been authenticated as a recognized user and the controller 120 and/or the interface application will log the recognized user into the device 100. In another embodiment, if the captured face does not match an image of a recognized user or if the object 160 is not determined to include a face, the image capture component 130 attempts to detect another object within the environment to determine whether the object is a person.

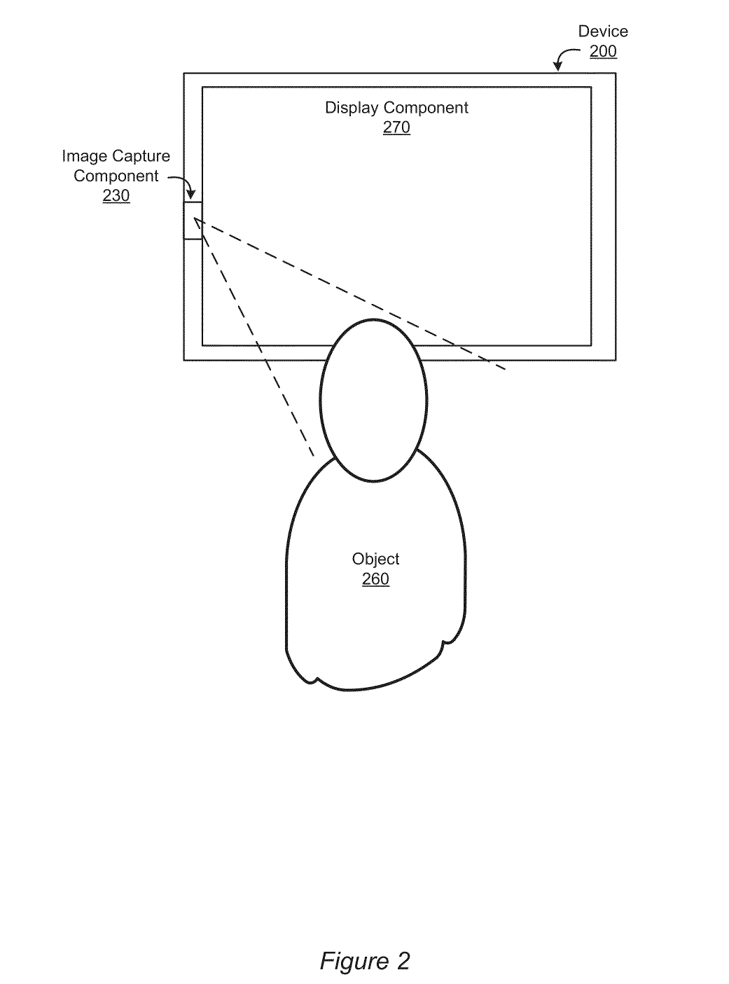

FIG. 2 illustrates an image capture component 230 detecting an object 260 according to an example. As noted above, the image capture component 230 is a hardware component which includes an image sensor, such as a CCD sensor or a CMOS sensor, to can capture a view of an environment of the device 200. In one embodiment, the image capture component 230 is a camera, a webcam, and/or an additional component which includes an image sensor to capture a view of the environment. The environment includes a location of the device 200.

The image capture component 230 captures an image and/or a video to capture a view of the environment. Additionally, the image capture component 230 can utilize motion detection technology to detect for movement within the environment. If any motion is detected in the environment, an object 260 will have been detected. The image capture component 230 can then proceed to detect a distance of the object 260 for the controller and/or the interface application to determine if the object 260 is within proximity of the device. In one embodiment, the image capture component 230 can emit one or more signals at the object and detect for a response. A time of flight for the signal to return can be utilized to identify the distance of the object 260. In other embodiments, the controller, the interface application, and/or the image capture component can use additional methods to detect to identify the distance of the object 260.

The controller and/or the interface application can compare the identified distance of the object 260 to a predefined distance to determine if the object 260 is within proximity of the device 200. In one embodiment, the predefined distance can be based on a distance which a user may typically be from the image capture component 230 for the image capture component 230 to capture a suitable image of a user's face. The predefined distance can be defined by the controller, the interface application, and/or a user of the device 200. If the identified distance of the object 260 is less than or equal to the predefined distance, the controller and/or the interface application determine that the object 260 is within proximity of the device 200.

If the object 260 is within proximity of the device 200, the controller and/or the interface application can proceed to use the image capture component 230 to identify a brightness level of the object 260. As noted above, the brightness level of the object 260 corresponds to an amount of light reflected off a surface of the object 260. In one embodiment, the image capture component 230 can detect an amount of ambient light reflected off of the surface of the object 230 to identify the brightness level of the object 260. In another embodiment, the image capture component 230 can output one or more signals as wavelengths and detect an amount of light reflected from the surface of the object 260 to identify the brightness level of the object 260.

While the image capture component 230 is identifying a brightness level of the object 260, the image capture component 230 detects for the object 260 repositioning. If the object 260 repositions from one location to another, the image capture component 230 can track the object 260 and redetect a brightness level of the object 260. As a result, the brightness level of the object 260 can continue to be updated as the object 260 moves from one location to another.

In another embodiment, if the object 260 is not detected within proximity of the device 200, a display component 260 of the device 200 can display one or more messages indicating that the object 260 is too far. As illustrated in FIG. 2, the display component 270 is an output device, such as a LCD (liquid crystal display), a LED (light emitting diode) display, a CRT (cathode ray tube) display, a plasma display, a projector and/or any additional device configured to display one or more messages. In another embodiment, the device 200 can include an audio speaker to output one or more of the messages.

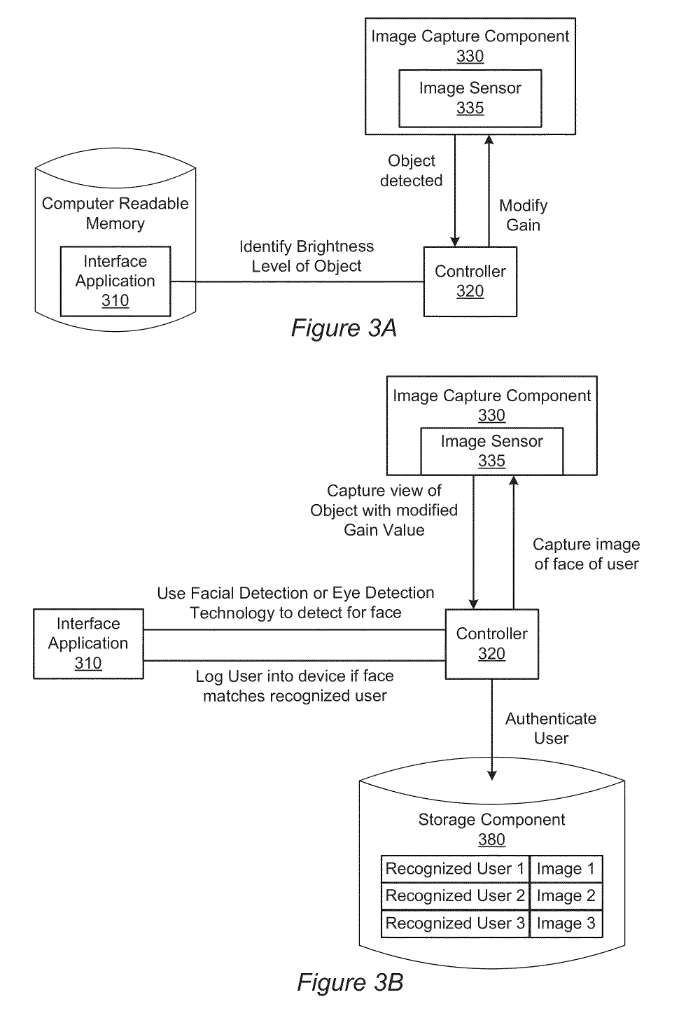

FIG. 3A illustrates a block diagram of an interface application 310 identifying a brightness level of an object according to an example. As noted above and shown in FIG. 3A, the interface application 310 can be firmware of the device or an application stored on a computer readable memory accessible to the device. The computer readable memory is any tangible apparatus, such as a hard drive, a compact disc, a flash disk, a network drive or any other form of computer readable medium that contains, stores, communicates, or transports the interface application 310 for use by the device.

As shown in FIG. 3A, the image capture component 330 has detected an object within proximity of the device. Additionally, the image capture component 330 has detected an amount of light reflected from a surface of the. In one embodiment, the image sensor 335 of the image capture component 330 can include a value corresponding to an amount of light detected from the surface of the object. The controller 320 and/or the interface application 310 can access the value from the image sensor 335 to identify the brightness level of the object.

In response to identifying the brightness level of the object, the controller 320 and/or the interface application 310 proceed to modify a gain value of the image capture component 330 based on the brightness level of the object. As noted above, the gain value corresponds to an amount of power supplied to the image sensor 335 of the image capture component 330. By modifying the gain value, the image sensor 335 can control an amount of power supplied for the image sensor 335 to modify a brightness of a view captured by the image capture component 330. The device can include a power source, such as a battery (not shown), to increase or decrease an amount of power supplied to the image sensor 335.

In one embodiment, modifying the gain value includes overwriting a default gain value of the image capture component 330. In another embodiment, modifying the gain value includes the controller 320 and/or the interface application 310 ignoring an instruction to decrease or increase the gain value based on a brightness level of another object detected in the environment or a background brightness level of the environment.

As noted above, the gain value used for the image sensor 335 is based on a midpoint of the dynamic range of brightness levels of the image sensor 335. Additionally, modifying the gain value includes using the brightness level of the object as the midpoint of the dynamic range. In one embodiment, if the identified brightness level is greater than the default midpoint of a default dynamic range, the controller 320 and/or the interface application 310 can overwrite the default midpoint with the identified brightness level of the object. By overwriting the default midpoint with a greater brightness level, the controller 320 and/or the interface application 310 can decrease the gain value of the image sensor 335 to decrease a brightness of a view captured by the image capture component 330. As a result, the object does not appear oversaturated and details of the object are visible and clear.

In another embodiment, if the identified brightness level is less than the default midpoint, the controller 320 and/or the interface application 310 can overwrite the default midpoint with the identified brightness level of the object. By overwriting the default midpoint with a lower brightness level, the controller 320 and/or the interface application 310 can increase the gain value of the image sensor to increase a brightness of a view captured by the image capture component 330. By increasing the gain value, the lower brightness level of the object is accommodated for by increasing a brightness of a view captured of the object.

Overwriting the default midpoint with the identified brightness level include can also include modifying the dynamic range by increasing it and/or widening it. The dynamic range is increased and/or widened until the brightness level becomes the midpoint for the modified dynamic range. In another embodiment, the controller 320 and/or the interface application 310 can modify the dynamic range by shifting the dynamic range until the brightness level is the midpoint of the modified dynamic range.

FIG. 3B illustrates a block diagram of an interface application 310 using a modified gain value for an image capture component 330 according to an example implementation. By using a brightness level of an object as a midpoint for a dynamic range of brightness levels, the controller 320 and/or the interface application 310 can determine whether a brightness of a captured view is to be increased or decreased and proceed to modify the gain value of the image capture component 330 accordingly. As a result, details of the object can be properly illuminated for the image capture component 330 to capture a clear view of the object.

Using the captured view of the object, the controller 320 and/or the interface application 310 can determine whether the object is a person. As noted above, the controller 320 and/or the interface application 310 can utilize facial recognition technology and/or eye detection technology to detect for a face or eyes on the object. If the controller 320 and/or the interface application 310 detect a face or eyes on the object, the object will identified to be a person. The controller 320 and/or the interface application 310 can then proceed to capture an image of the face for the controller 320 and/or the interface application 310 to authenticate the user.

Authenticating the user includes determine if the person is a recognized user of the device. As shown in the present embodiment, the controller 320 and/or the interface application 310 can access a storage component 380 to access images of one or more recognized users of the device. The storage component 380 can be locally stored on the device or the controller 320 and/or the interface application 310 can access the storage component 380 from a remote location. The controller 320 and/or the interface application 310 can compare the captured image of the face to images of one or more of the recognized users.

If the captured image of the face matches any of the images corresponding to a recognized user of the device, the controller 320 and/or the interface application 310 identify the person to be a recognized user of the device. As a result, the person will have been authenticated and the controller 320 and/or the interface application 310 proceed to log the recognized user into the device. In one embodiment, logging the recognized user into the device includes granting the recognized user to data, content, and/or resources of the device.

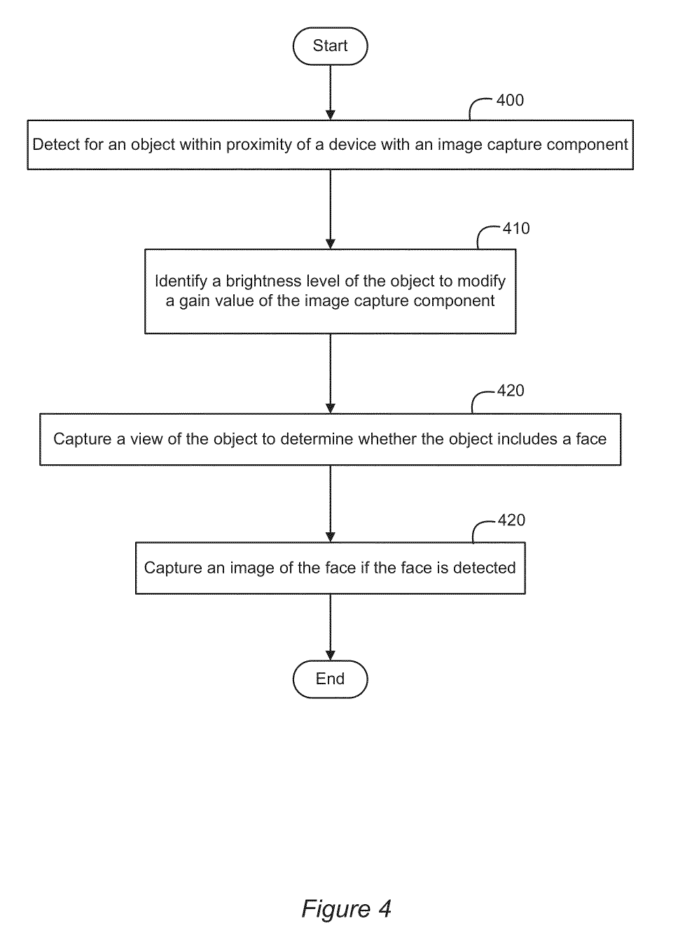

FIG. 4 is a flow chart illustrating a method for detecting a user according to an example. A controller and/or interface application can be utilized independently and/or in conjunction with one another to manage the device when detecting for a user. The controller and/or the interface application initially use an image capture component to detect for an object within proximity of the device at 500. The image capture component can capture a view of an environment around the device to detect for any motion in the environment. If any motion is detected, an object will have been detected.

The image capture component can then identify a distance of the object for the controller and/or the interface application to compare to a predefined distance. If the identified distance of the object is less than or equal to the predefined distance, the controller and/or the interface application determine that the object is within proximity of the device. In response to detecting the object within proximity of the device, the controller and/or the interface application proceed to identify a brightness level of the object to modify a gain value of the image capture component at 410.

The image capture component can detect for an amount of light reflected from a surface of the object. The amount of light reflected can be identified by the controller and/or the interface application to be the brightness level of the object. The controller and/or the interface application can then access a default dynamic range of brightness levels for the image sensor of the image capture component. The identified brightness level of the object is compared to a default midpoint of the range of brightness levels.

If the identified brightness level of the object is greater than the default midpoint, the controller and/or the interface application can overwrite the default midpoint and proceed to decrease the gain value of the image capture component accordingly. As noted above, decreasing the gain value includes decreasing an amount of power supplied to the image sensor for the image capture component to decrease a brightness of the view of the object captured so that details of the object do not appear to be oversaturated. In another embodiment, if the identified brightness level of the object is less than the default midpoint, the controller and/or the interface application can overwrite the default midpoint and increase the gain value of the image capture component accordingly. Increasing the gain value includes increasing an amount of power supplied to the image sensor for the image capture component to increase a brightness of the view of the object so that details of the object are visible.

Using the modified gain, the image capture component can capture a view of the object to detect for a face on the object at 420. The controller and/or the interface application can use eye detection technology and/or facial detection technology to detect for a face. If a face is detected, the controller and/or the interface application will determine that the object is a person and attempt to authenticate the user as a recognized user of the device. The image capture component can capture a face of the person for the controller and/or the interface application to authenticate at 420. The method is then complete. In other embodiments, the method of FIG. 4 includes additional steps in addition to and/or in lieu of those depicted in FIG. 4.

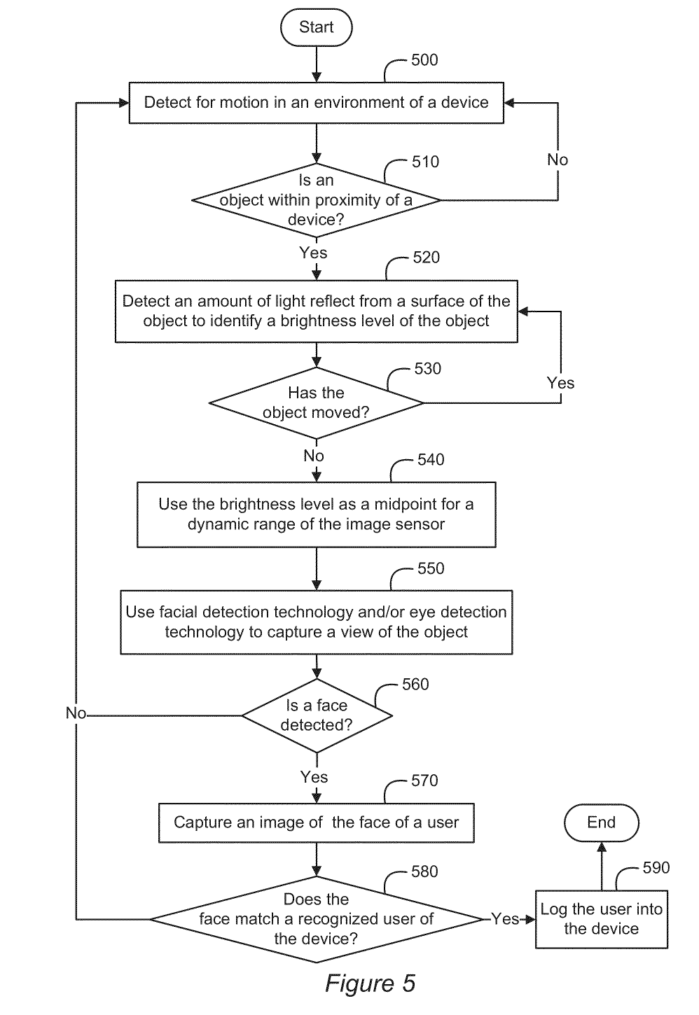

FIG. 5 is a flow chart illustrating a method for detecting a user according to another example. An image capture component initially captures a view of an environment to detect for motion in the environment at 500. If any motion is detected, an object will have been detected and the controller and/or the interface application proceed to determine if the object is within proximity of the device at 510. The image capture component detects a distance of the object for the controller and/or the interface application to compare to a predefined distance corresponding to a typical distance a user may be for the image capture component to capture a suitable image of the user's face.

If the identified distance is less than or equal to the predefined distance, the object will be determined to be within proximity and the image capture component proceeds to detect an amount of light reflected from a surface of the object for the controller and/or the interface application to identify a brightness level of the object at 520. In another embodiment, if the identified distance is greater than the predefined distance, the object will be outside proximity and the image capture component continues to detect for an object within proximity of the device.

As the controller and/or the interface application are identifying the brightness value of the object, the image capture component can detect for the object moving 530. If the object is detected to move, the image capture component can continue to detect an amount of light reflected from the surface of the object and the brightness level of the object can be updated at 520. If the object does not move, the controller and/or the interface application can use the brightness level of the object as a midpoint for a dynamic range of brightness levels of the image sensor at 540.

As noted above, the image capture component can include a default gain value based on a default midpoint for the dynamic range of brightness levels of the image sensor. As the midpoint of the dynamic range is modified, the gain value for the image capture component is modified accordingly. In one embodiment, if the brightness level of the object is greater than the midpoint, the gain value can be decreased. As a result, an amount of power supplied to the image sensor is decreased for a brightness of the captured view to be reduced. In another embodiment, if the brightness level of the object is less than the midpoint, the gain value can be increased. As a result, an amount of power supplied to the image sensor is increased for the brightness of the captured view to be increased.

As the image capture component captures the view of the object with a modified view, the controller and/or the interface application can utilize facial detection technology and/or eye detection technology at 550. The controller and/or the interface application can determine if a face is detected at 560. If the object is detected to include a face or eyes, the object will be identified as a person and the image capture component can capture an image of the face with the modified gain at 570. The controller and/or the interface application can determine if the captured image of the face matches an image of a recognized user of the device at 580.

If the image of the face matches an image of a recognized user, the controller and/or the interface application will log the user into the device at 590. In another embodiment, if no face is detected or if the face does not match any of the images of recognized users, the image capture component can move onto another object in the environment or continue to detect for any object within proximity of the device at 500. In other embodiments, the method of FIG. 5 includes additional steps in addition to and/or in lieu of those depicted in FIG. 5.

What is claimed is:

1. A method for detecting a user comprising:
detecting for an object within proximity of a device with an image capture component;
identifying a brightness level of the object to modify a gain value of the image capture component;
capturing a view of the object to determine whether the object includes a face; and
capturing an image of the face if the face is detected.

2. The method for detecting a user of claim 1 wherein detecting for an object includes an image capture component of the device detecting for motion in an environment around the device.

3. The method for detecting a user of claim 1 wherein identifying the brightness level includes detected an amount of light reflected from a surface of the object.

4. The method for detecting a user of claim 1 wherein modifying the gain value of the image capture component includes using the brightness level of the object as a midpoint for a dynamic range of the image capture device.

5. The method for detecting a user of claim 1 further comprising using at least one of facial detection technology and eye detection technology to determine whether the object includes a face.

6. The method for detecting a user of claim 1 further comprising authenticating the user with the image of the face and logging the user into the device if the user is authenticated.

7. A device comprising:
an image capture component to capture a view of an environment to detect an object within proximity of the device; and
a controller to identify a brightness level of the object and modify a gain value of the image capture component based on the brightness level;
wherein the controller determines whether the object includes a face and captures an image of the face if the face is detected.

8. The device of claim 7 wherein the image capture component tracks the object if the object repositions from one location to another.

9. The device of claim 8 wherein the controller updates the brightness level of the object and modifies the gain value if the object is detected to reposition.

10. The device of claim 7 wherein modifying a gain of the view includes the controller using the brightness level as a midpoint for a dynamic range of the image capture component.

11. The device of 10 wherein modifying the gain includes increasing a brightness of the view.

12. A computer readable medium comprising instructions that if executed cause a controller to:
capture a view of an environment with an image capture component to detect for an object within proximity of a device;
identify a brightness level of the object to modify a gain value of the image capture component; and
determine whether the object includes a face and capture an image of the face if the face is detected.

13. The computer readable medium of claim 12 wherein the controller overwrites a default gain of the image capture device if modifying the gain of the view.

14. The computer readable medium of claim 12 wherein the controller ignores an instruction to decrease the gain of the image capture component.

15. The computer readable medium of claim 12 wherein the image capture component uses motion detection technology to determine if the object is detected in the environment around the device.
